(19) United States
(12) Patent Application Publication
(10) Pub. No.: US 2010/0305867 A1
(43) Pub. Date: Dec. 2, 2010

(54) ANALYSIS OF AQUIOUS SAMPLE BY LIGHT TRANSMITTENCE

(76) Inventor: Peter E. Rising, Brightwaters, NY (US)

Correspondence Address: F. CHAU & ASSOCIATES, LLC, 130 WOODBURY ROAD, WOODBURY, NY, 11797, US

(21) Appl. No.: 12/278,218

(22) PCT Filed: Feb. 5, 2007
(86) PCT No.: PCT/US07/03048

§ 371 Date: Aug. 4, 2008

Related U.S. Application Data
(60) Provisional application No. 60/764,957, filed on Feb. 3, 2006.
(60) Provisional application No. 60/831,527, filed on Jul. 17, 2006.

(51) Int. Cl. G06F 19/00; G01N 21/59; G06F 17/18

(52) U.S. Cl. 702/19; 356/436

(57) ABSTRACT

A method for analysis of an aqueous sample includes determining a first reading of a sample, and comparing the first reading to a first read index to determine a first read probability wherein the first read probability gives either a positive or a negative result for the sample. The method includes determining a second reading for the sample, and comparing the second reading to a second read index, wherein a second read probability is determined according to the reading and the second read index. The second read probability gives either a positive or a negative result for the sample. From the first and second readings, a species and a life phase of the species are determined.

### CROSS-REFERENCE TO RELATED APPLICATIONS

This application claims priority to U.S. Provisional Application Ser. Nos. 60/764,957, filed on Feb. 3, 2006, and 60/831,527, filed on Jul. 17, 2006, which are herein incorporated by reference in their entirety.

### BACKGROUND OF THE INVENTION

1. Technical Field

The present invention relates to a system and method for analyzing contents of an ampoule, and more particularly to a program of instructions performed by a computer for analyzing the contents of the ampoule.

2. Discussion of Related Art

Biologists use indicator chemicals to enhance and accelerate the identification of microbial colonies when attempting to determine microbial concentration levels for specific samples being tested. One of the problems identified with using such indicator chemicals is that they can have a reaction to non-microbial stimuli such as treatment chemicals and drugs. This is particularly true for broad-spectrum microbial indicators such as TTC and other ORP indicator chemicals that are used in the enumeration of aerobic microbes present in a sample. This chemical positive reaction is particularly true of but not limited to microbial tests that use an aqueous testing matrix. The presence of reductive chemicals causes the TTC indicator to turn the normal end of test red hue whether microbes are present or not. This situation may lead to a false positive for microbes test result or an erroneous microbial concentration level determination. In some microbial testing applications, such as the culturing of urine samples, a false position may result from various types of antioxidant therapy (e.g., vitamin C and etc.) or certain types of antibiotics. The elimination of chemical positive results that are not biologically positive has a positive effect upon the microbial test analysis, as test results are not delayed by secondary tests. The occurrence of such chemical positive/biologic negative test results can vary greatly and in an unpredictable or known manner from one test application to another test application. Similar undesired test variation can occur from one sample to another sample with an application because of reasons of sample environment change. As an example for human urine testing a person providing a urine sample who is on antioxidant therapy can provide a chemically positive test sample which is not biologic positive in the morning period but provide a chemically negative and biologically negative in the afternoon. This occurs when the urine residuals of oxidant materials are high based upon the amount of antioxidant taken, time of dose and relative chemical health of the individual at the time of sampling. Similar difficulty can occur with samples taken from closed loop water-cooling systems. This result is particularly true for medical applications where the application of medicinal steps is made faster and fewer cases of antibiotic over dosing occur.

The enumeration and speciation of microbial populations may include the use various kinds of media plates, slants and or agar swabs. These analysis techniques do not yield, by themselves, the growth phase of a microbial population. Known techniques merely determine microbial presence, level and species. If the biologic analyst wishes to determine the growth phase of a microbial population at sampling time, a series of time consuming tests and calculations need to be performed with the specific intent of estimating the growth phase of the microbial population. For example, a test may take several days to complete, subjecting the results to further error due to aging samples. Further, results may become irrelevant for corrective use as the patient might have died or the condition changed drastically. Growth phase of microbial populations is an important defining attribute in the analysis and control of many microbial populations.

Methods for speciation in samples having mixed microbe populations can be difficult. For example, in a mixed population, attempts to determine a particular species that may be the cause of an infection, e.g., a species having a highest concentration, are complicated by detection techniques. Typically, samples containing mixed microbe populations are discarded as unreadable negative samples. In other cases, to determine the species in the sample, the sample is plated and grown on a media. Thus, all species in the sample are provided the opportunity for growth. Therefore, it can be difficult to determine a species of interest, e.g., a cause of an infection.

Therefore, a need exists for a program of instructions performed by a computer for analyzing the contents of the ampoule.

### SUMMARY OF THE INVENTION

According to an embodiment of the present disclosure, a method for analysis of an aqueous microbial sample includes determining a first reading of a sample, and comparing the first reading to a first read index to determine a first read probability wherein the first read probability gives either a positive or a negative result for the sample. The method includes determining a second reading for the sample, and comparing the second reading to a second read index, wherein a second read probability is determined according to the reading and the second read index. The second read probability gives either a positive or a negative result for the sample. From the first and second readings, a species and a life phase of the species are determined.

According to an embodiment of the present disclosure, a method for identifying a bacterial community in a sample includes providing the sample including the bacterial community, determining a first transmittance of a first wavelength of light through the sample, determining a second transmittance of a second wavelength of light through the sample, determining a ratio of the first transmittance to the second transmittance, comparing the ratio to a known ratio of a certain bacterial species, and determining a species of the bacterial community according to the comparison.

According to an embodiment of the present disclosure, a method for determining a life phase bacteria in a sample includes providing a grid map comprising a plurality of areas, each area having a probability of log life phase and a probability of lag life phase, the grid map comprising light transmission data of two wavelengths of light, determining for the sample first light transmission data of the two wavelengths of light, plotting the first light transmission data of the sample on the grid map, and determining a probability for the life phase of the bacteria in the sample.

### BRIEF DESCRIPTION OF THE DRAWINGS

Preferred embodiments of the present invention will be described below in more detail, with reference to the accompanying drawings:

FIG. 1A-B are flow charts of a method for analyzing an aqueous sample according to an embodiment of the present disclosure;

FIG. 2 is a diagram of a system according to an embodiment of the present disclosure;

FIGS. 3A-B are flow charts of a method for analyzing an aqueous sample according to an embodiment of the present disclosure;

FIG. 4 is a graph of light transmittance ratios for different species according to an embodiment of the present disclosure;

FIG. 5 is a flow chart of a method according to an embodiment of the present disclosure;

FIGS. 6A-C show plots for first, second and third reads, according to an embodiment of the present disclosure;

FIG. 7 is a plot of average value movement over time according to an embodiment of the present disclosure;

FIGS. 8A-B are scatter-plots for visual and infrared (IR) response for samples according to an embodiment of the present disclosure;

FIG. 9 is a graph progression showing negative samples at 1, 2 and 3 hours according to an embodiment of the present disclosure; and

FIG. 10 is a graph progression showing positive samples at 1, 2, and 3 hours according to an embodiment of the present disclosure.

### DETAILED DESCRIPTION OF PREFERRED EMBODIMENTS

According to an embodiment of the present disclosure, a sample contained in an ampoule can be analyzed by determining characteristics of light passing through the sample as done by the IME.TEST™ Autoanalyzer.

According to an embodiment of the present disclosure, predetermined growth curves for biologic activity may be used in first read determinations (e.g., positive/negative for presence), log/lag phase determinations in time to concentrations analysis, and microbe identification. These growth curves may be determined using an infrared (IR) measurement in combination with one or more different visible wavelengths of light.

A spectrophotometer is used to read and record light transmission through an aqueous sample, measures are recorded in a test record. The sample is taken and wavelengths are selected for first read analysis, these wavelengths for testing are available through the spectrophotometer having different light sources. A determination of potentially positive samples may be made using the first read analysis. The samples, e.g., potential positive samples, may be incubated and a second read is performed for each wavelength of the first read. A change in light transmission through the sample over time is determined, e.g., using the first and second readings. For example, if an increase in absorbance and/or a decrease in transmittance in a visible wavelength (indicating microbial respiration) and an IR wavelength (indicating microbial multiplication) is determined than the sample is confirmed to be positive. Negative samples may be rapidly (in about 10-20 seconds) determined at high confidences, about 90% or better, during the first read analysis and discarded. Further, by comparing the curves for light transmission over time with known curves for a given species, a species of the sample can be determined. For example, a human urine analysis for 10⁶ microbial concentration using 580 nm and 800 nm at 2 hours of incubation is considered positive if the 580 nm drops 10% T (transmission rate) or more and the 800 nm reading drops 20% T or more. With the predetermined spectral change information, the sample may be withdrawn from incubation and read spectrophotometrically a second time. The spectral output change is then compared to the predetermined values for change to be classified positive or negative. If a change in light transmittance satisfies a known value for a positive sample, the sample is considered positive and in the log phase of growth at time of sampling. If a change in light transmittance satisfies a known value of a negative sample, the sample is considered negative for the light wavelengths being tested and any bacteria present are in lag phase.

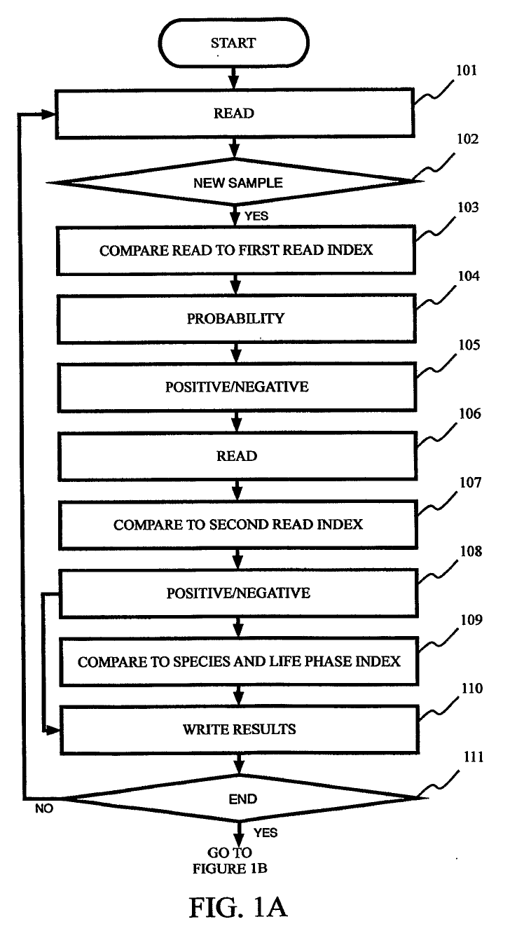

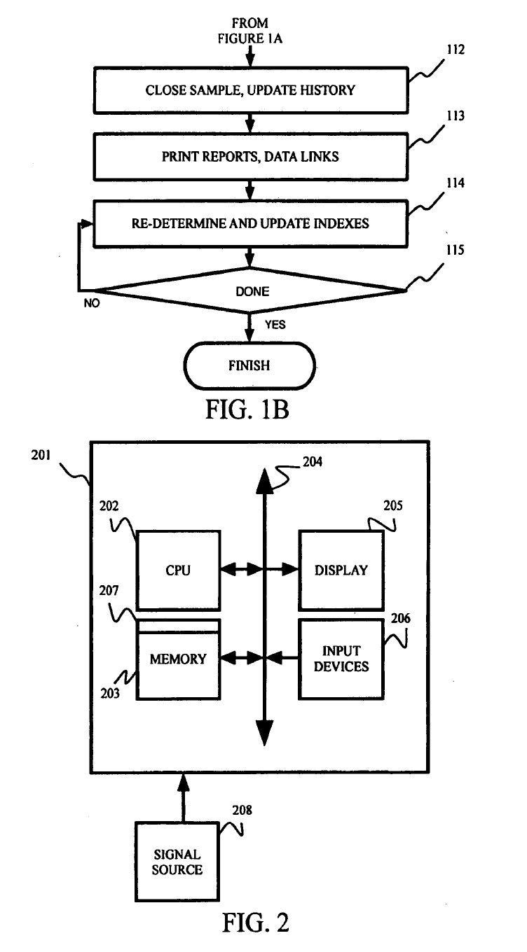

Referring to FIG. 1A, a first reading of a sample (e.g., light transmission through the sample at one or more wavelengths) is determined 101. If the reading is a first reading for the sample 102, the reading is compared to a first read index 103. A first read probability is determined according to the reading and the first read index 104. The first read probability gives either a positive or a negative result for the sample 105. The positive or negative result is associated with the sample. A second reading is determined 106 at a predetermined time after the first reading. The reading is compared to a second read index 107. A second read probability is determined according to the reading and the second read index 107. The second read probability gives either a positive or a negative result for the sample 108. According to the result (e.g., positive or negative) the sample is may be handled separately; for positive samples, values of the first and second readings are compared to a species and life phase index to determine a species and life phase of a bacteria in the sample 109. The results, e.g., that a sample is negative or that a sample is positive and is associated with a certain species having a certain life phase, are written to a file 110. It is determined whether an end of a batch of samples has been reached 111.

Referring to FIG. 1B, if an end of a batch has been reached the sample(s) is closed and a history is updated 112. Optionally, reports may be printed and data links are updated. The data links are the association of a given ampoule over multiple tests. An updated history may be used to re-determine and update the indexes used to positive and negative determinations as well as for species and life phase identification (see blocks 103 and 109) 114. Accordingly, as additional samples are processed, the indexes become more reliable. Further, through the updating of indexes may react to changes in bacterial evolution over time. Each index is updated 115 and the routine is finished.

According to an embodiment of the present disclosure, a result for the presence of a certain microbe is automatically returned, for example, to a display, printout, or database. Each reading and a result (e.g., positive/negative of presence and life cycle) may be encoded with information including, operator, date, time, batch number, etc. The encoded information may be used to update indexes and/or stored in a database.

It is to be understood that the present invention may be implemented in various forms of hardware, software, firmware, special purpose processors, or a combination thereof. In one embodiment, the present invention may be implemented in software as an application program tangibly embodied on a program storage device. The application program may be uploaded to, and executed by, a machine comprising any suitable architecture.

Referring to FIG. 2, according to an embodiment of the present invention, a computer system 201 for executing a program of instructions for analyzing the contents of the ampoule can comprise, inter alia, a central processing unit (CPU) 202, a memory 203 and an input/output (I/O) interface 204. The computer system 201 is generally coupled through the I/O interface 204 to a display 205 and various input devices 206 such as a mouse and keyboard. The support circuits can include circuits such as cache, power supplies, clock circuits, and a communications bus. The memory 203 can include random access memory (RAM), read only memory (ROM), disk drive, tape drive, etc., or a combination thereof. The present invention can be implemented as a routine 207 that is stored in memory 203 and executed by the CPU 202 to process the signal from the signal source 108. As such, the computer system 201 is a general purpose computer system that becomes a specific purpose computer system when executing the routine 207 of the present invention.

The computer platform 201 also includes an operating system and micro instruction code. The various processes and functions described herein may either be part of the micro instruction code or part of the application program (or a combination thereof), which is executed via the operating system. In addition, various other peripheral devices may be connected to the computer platform such as an additional data storage device and a printing device.

It is to be further understood that, because some of the constituent system components and method steps depicted in the accompanying figures may be implemented in software, the actual connections between the system components (or the process steps) may differ depending upon the manner in which the present invention is programmed. Given the teachings of the present invention provided herein, one of ordinary skill in the related art will be able to contemplate these and similar implementations or configurations of the present invention.

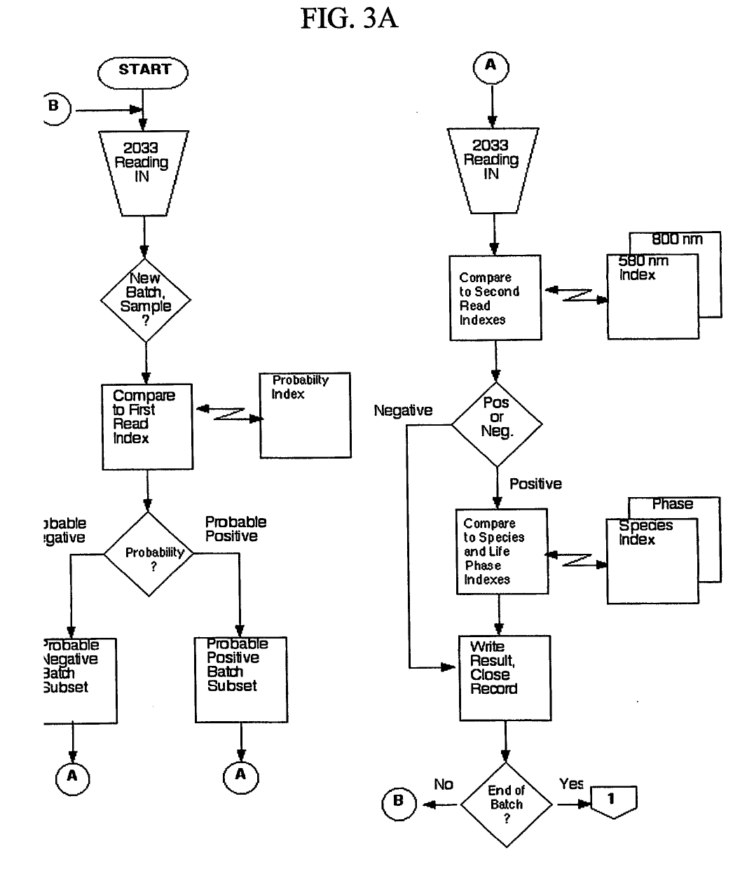

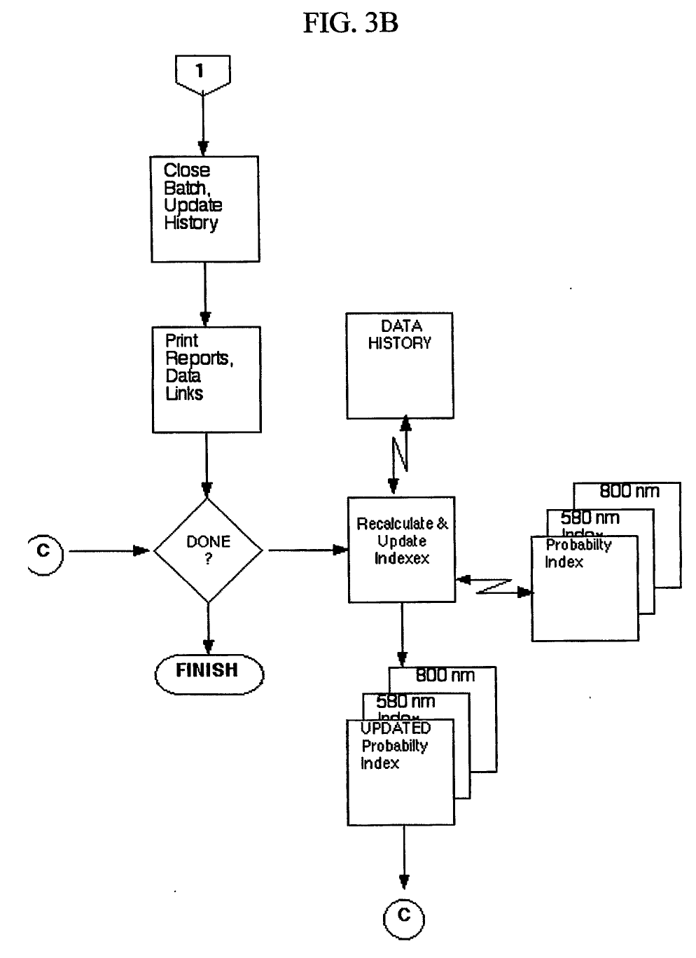

FIGS. 3A-B are an example of a flow chart of a method for analyzing an aqueous sample according to an embodiment of the present disclosure.

According to an embodiment of the present disclosure, liquid samples including a bacterial community where analyzed using an auto-sequencing spectrophotometer using 580 nm and 800 nm wavelength light, for tracking light transmittance over time.

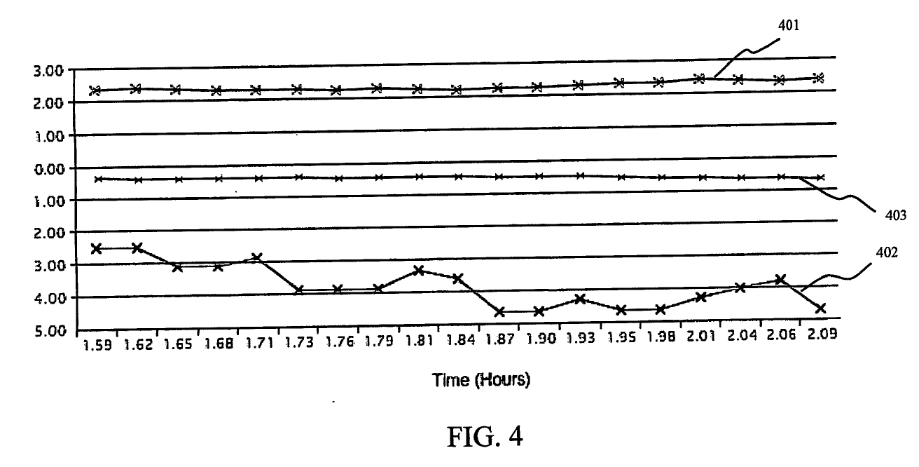

Referring to FIG. 4, a species may be identified according to a ratio of light transmittance between two or more different wavelengths of light. For example, Escherichia coli (E. coli) has a ratio of about 2.4 401. The ratio corresponds to a light transmittance through the sample over time, such that, for example, the transmittance of 800 nm light through E. coli, is about 2.4 times greater than that of 580 nm light. An inverse ratio may also be used, e.g., 580 nm/800 nm. Different bacteria exhibit different responses, for example, as shown in FIG. 4, Klebsiella 402 and Pseudomonas 403 exhibit different ratios then each other and different from E. coli 401. More particularly, different bacteria have different masses and respiration rates. For example, comparatively, E. coli has small mass and fast respiration while Enterococcus exhibits large mass and slow respiration. These traits are borne out in the identifying ratios, which are leveraged in a method for identification.

Using the determined ratios of different species, a determination of species may be achieved using a substantially instantaneous evaluation of the ratio of light transmittance at a point in time. For example, a determination of the ratio over time is not needed for identification.

A certain bacterial species may exhibit a variable ratio, as in the case of Klebsiella, such a curve may be used to identify the species over time, adding certainty to a given determination.

Deviations from a known ratio, e.g., 2.4 for E. coli, may be an indication of culture pureness. One of ordinary skill in the art would appreciate that deviations and measures of pureness may be determined through experimentation. Variation from a known ratio tends to indicate species purity, providing a means for identifying multi-species samples.

According to micro-biological standards, samples including more than two species are deemed contaminated and are dismissed as unreadable negative samples, as in the case of mid-stream urine analysis. Further analysis of these samples may relveil log phase growth of one or more species, indicating an active infection—which may have been missed by dismissing the sample as contaminated. Multi-species samples may be readily detected as deviations from known ratios.

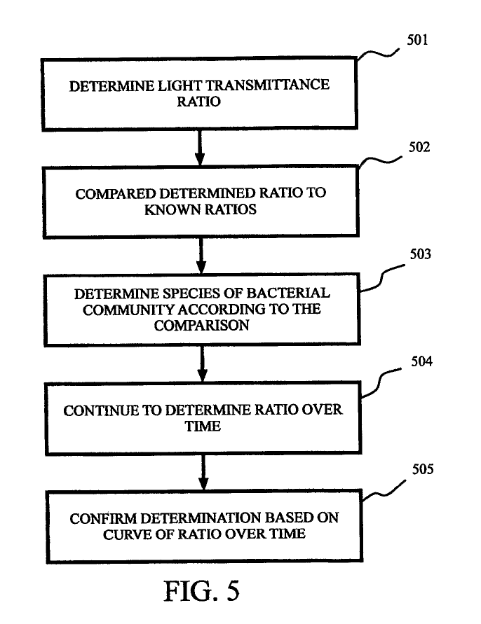

Referring to FIG. 5, a method according to an embodiment of the present disclosure includes determining a ratio of light transmittance of two wavelengths of light, which measure different aspects of microbial activity (e.g., respiration and multiplication), through a sample including a bacterial community 501. A determined ratio is compared to known ratios for different bacterial communities 502, and a determination of species is made based on a best fit 503.

Further, the ratio may be determined over time 504. Given a determination of the ratio over time, a confidence in the determination can be increased; the determination may be confirmed 505. For example, for a species such as Klebsiella with a ratio that varies over time, one can deduce that an unknown sample includes Klebsiella, as the sample's ratio would track along a substantially similar plot over time.

Referring to box 502, comparing the determined ratios to the known ratios may include calibrating the determined ratios. The values of the light transmittance for the different wavelengths may vary due to, for example, light path distances. Thus, the known values for each wavelength may be standardized for a certain device for reading transmittance or calibrated for different light path lengths.

Embodiments of the present disclosure can demonstrated by the use of the IME.TEST™ Ampoule and IME.TEST™ Auto Incubator/Autoanalyzer or the combined use of a standard laboratory Incubator and spectrophotometer.

Referring again to FIG. 2, according to an embodiment of the present invention, the computer system 301 may be implemented for identifying bacteria according to a combined measure of light transmission through a sample at different wavelengths.

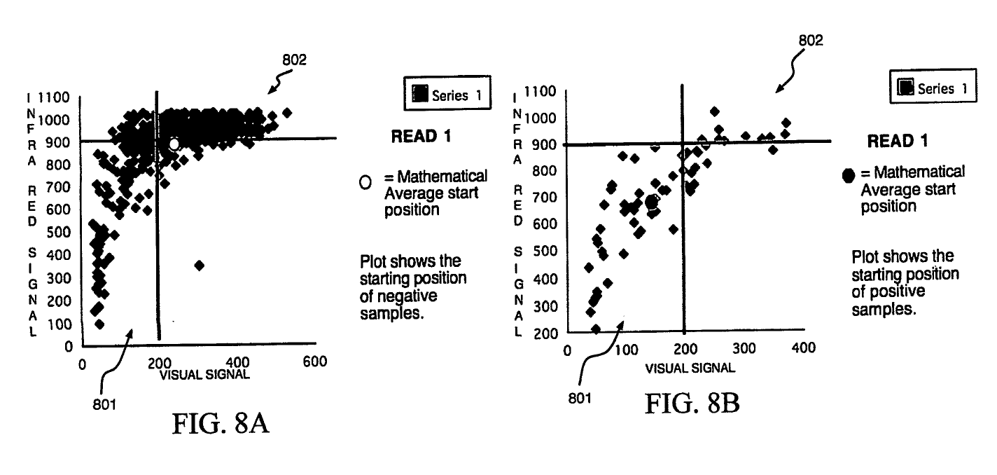

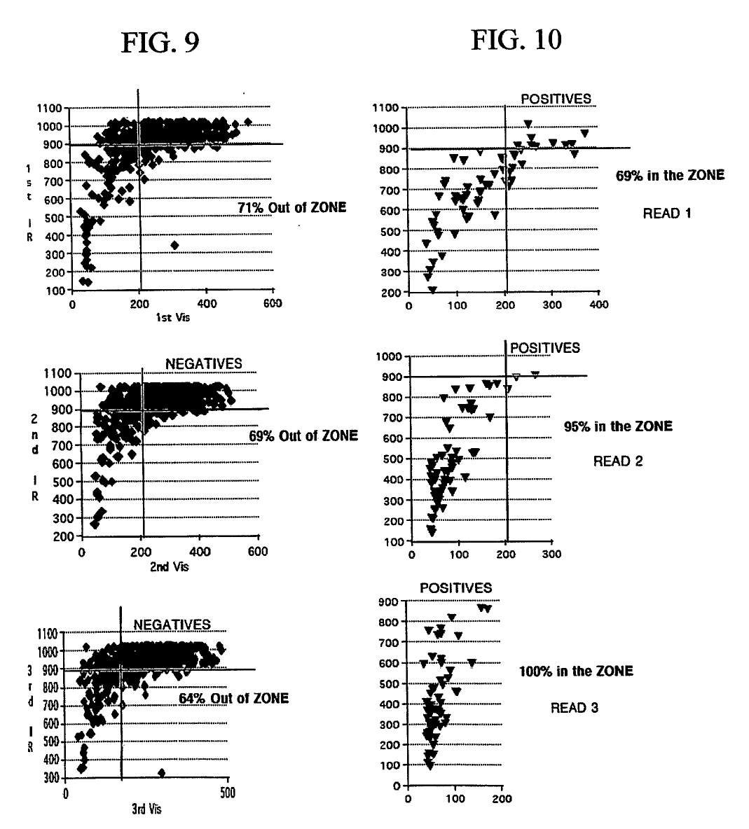

According to an embodiment of the present disclosure, a grid map is created that segments visible and IR readings into sections, for example, 4 quadrants, and a determination of positive/negative may be made according to an observations plot (see for example, FIGS. 8A-B). For example, a particular value for each of visible and IR is optimized for the determination. For example, FIGS. 8A-B show positive and negative samples, wherein samples above about 900 in the infrared tend to be negative and the lower left quadrant tend to be positive. FIGS. 9 and 10 show negative and positive samples, respectively. From FIG. 9 is can be seen that at 1 hour (1^{st} vis) 71% of samples are outside of the bottom left quadrant, and this measure does not significantly change at 2 hours (2^{nd} vis). For positive samples in FIG. 10, 69% of samples are in the bottom left quadrant at 1 hour (read 1) and 95% of positive samples are in the bottom left quadrant at 2 hours (read 2). Results at 3 hours are shown in FIG. 9 (3^{rd} vis) and FIG. 10 (read 3).

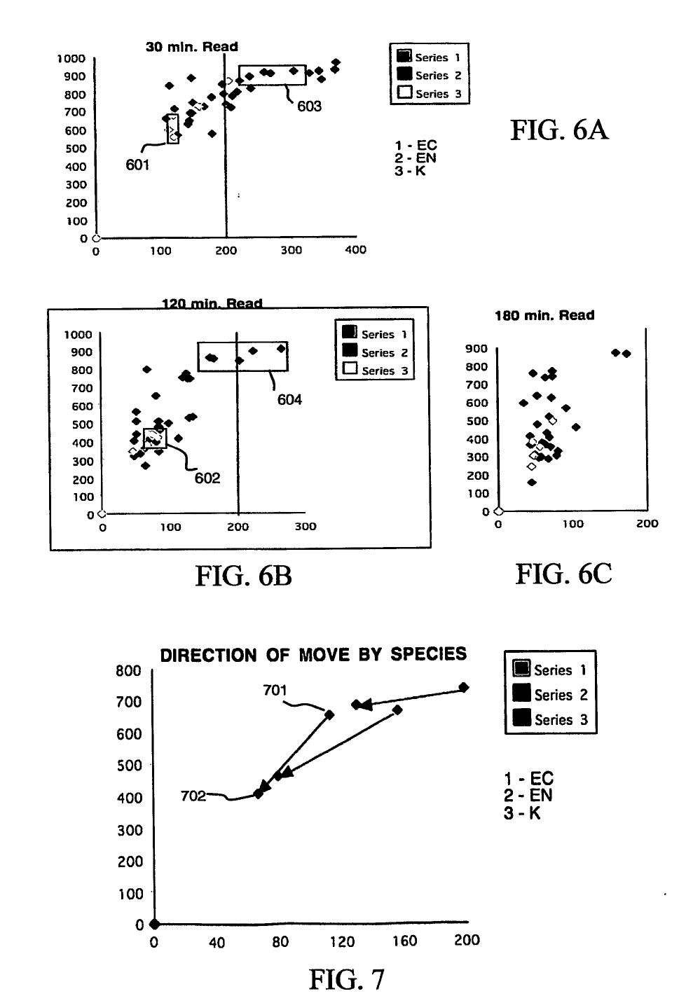

Using the probabilities from FIGS. 9 and 10, grid analysis may be used to refine a probability of positive or negative as determined using first read analysis, e.g., see FIGS. 1A-B wherein the probability that a sample is negative or positive is given based on determined values of light transmission through a sample as compared to a known value for a given species. By adding a probability that a sample is in a log phase using for example, FIGS. 6A-B, a further increase in confidence can be achieved, e.g., with confidences at about 98% for positive/negative determinations of log/lag phase growth.

Positive examples selected from FIGS. 8A-B are shown in FIGS. 6A-C over time, in which areas 601 and 603 are a characteristic to Enterococcus samples over time, while areas 602 and 604 are characteristics to Klebsiella samples over time. The selection of areas negative for microbial growth may be determined based on a master plot of microbial loci of a number of samples, e.g., 500, with a normal distribution of positives. The plot of actual visible and IR loci is done at certain time intervals for all samples, for example, taking a first read at 30 min., a second read at 120 min. and third read at 180 min (see for example, FIGS. 6A-C showing results for E. coli (series 1/EC), Enterococcus (series 2/EN) and Klebsiella (series 3/K)). The time for reading may be different, for example, the first read may be taken at 15 min. Based upon the resulting charts, which are loaded into a decision calculator (e.g., computer software) unknown samples are compared to the historic grid and an accurate first read (e.g., about 95% confidence or better) positive versus negative selection can be made (for example, see FIGS. 8A-B). Additionally, after a second read, a comparison for a new location versus starting location plus direction of change can be predictive of microbial species (see for example, FIG. 7 in which 701 is a starting location and 702 is a new location).

Mathematical ratios for % P (positive) and species improve the selection of negative samples and rapid prediction of species.

On the subject of visible and IR signals, not only does the IR signal confirm viable microbial growth in log phase but it also demonstrates the degree of log versus lag phase. Microbes that have 100% respiration when compared to a standard performance curve may or may not be log phase. The comparison to a similar standard performance curve for IR signal output will determine whether the microbes tested are in log phase. This ability to determine the degree of log phase will be important not only in the analysis of urine but may be extended to other fields, including for example waste water, where log phase microbial activity is needed for the sewage digestion process.

Referring to FIGS. 8A-B, a scatter gram of QuikiCult Screen Test visual and infra red (IR) response for samples agreed to by Gold Standard Culture and QuikiCult Screen Test as negative and positive using the visual and infra red coordinates. The QuikiCult Screen Test demonstrates that negatives and positives (e.g., as determined by respiration and multiplication) start the QuikiCult test in significantly different positions. A similar scatter gram of positives after 3 hours has all positives located in the lower left quadrant 801 (visible<200, IR<900) of the scatter gram. Negatives remain in the same position after 3 hours as the start scatter gram. There is a significant statistical indication for microbial negativity based upon QuikiCult start read (for example, see FIG. 6A). Positive examples tend to reside in the lower left quadrant 801. Negative examples tend to reside in the upper two quadrants 802. Accordingly, determinations may be made for samples based on their position in the grid, wherein areas of positive and negative examples may be changed according to data about particular species. Further, more than 4 areas may be used.

Having described embodiments for a program of instructions performed by a computer for analyzing the contents of the ampoule and for apparatus and method for identifying bacteria according to a combined measure of light transmission through a sample at different wavelengths, it is noted that modifications and variations can be made by persons skilled in the art in light of the above teachings. It is therefore to be understood that changes may be made in the particular embodiments of the invention disclosed.

What is claimed is:

1. A method for analysis of an aqueous microbial sample comprising:
determining a first light transmittance of a sample;
comparing the first light transmittance to a first read index to determine a first read probability wherein the first read probability gives either a positive or a negative result for the sample;
determining a second light transmittance for the sample; and
comparing the second light transmittance to a second read index, wherein a second read probability is determined according to the reading and the second read index, and wherein the second read probability gives either a positive or a negative result for the sample; and
determining from the first and second readings, a species and a life phase of the species.

2. A method for identifying a bacterial community in a sample comprising:
providing the sample including the bacterial community;
determining a first transmittance of a first wavelength of light through the sample;
determining a second transmittance of a second wavelength of light through the sample;
determining a ratio of the first transmittance to the second transmittance;
comparing the ratio to a known ratio of a certain bacterial species; and
determining a species of the bacterial community according to the comparison.

3. The method of claim 2, further comprising:
determining a curve of the ratio over time;
comparing the curve to a known curve of the certain bacterial species; and
confirming a determination of the species of the bacterial community.

4. The method of claim 2, further comprising:
determining a deviation of the ratio from the known ratio; and
determining a measure of pureness of the sample according to the deviation.

5. The method of claim 2, further comprising providing the known ratio of the certain bacterial species.

6. The method of claim 2, further comprising calibrating the determined ratio to the known ratio according to a light path distance used in determining the known ratio.

7. The method of claim 2, further comprising:
providing a light path distance used in determining the known ratio; and
calibrating a determined ratio to the known ratio according to the light path distance used in determining the known ratio.

8. A method for determining a life phase bacteria in a sample comprising:
providing a grid map comprising a plurality of areas, each area having a probability of log life phase and a probability of lag life phase, the grid map comprising light transmission data of two wavelengths of light;
determining for the sample first light transmission data of the two wavelengths of light;
plotting the first light transmission data of the sample on the grid map; and
determining a probability for the life phase of the bacteria in the sample.

9. The method of claim 8, wherein the first wavelength is an indication of microbial respiration and the second wavelength is an indication of microbial multiplication.

10. The method of claim 8, further comprising providing a time constraint of the light transmission data of two wavelengths of light.

11. The method of claim 8, further comprising:
plotting second light transmission data of the sample taken at a different time than the first light transmission data; and
determining a species according to a vector defined by the first and second light transmission data according to a known plot for the species.
